(19) United States
(12) Patent Application Publication
(10) Pub. No.: US 2017/0214072 A1
(43) Pub. Date: Jul. 27, 2017

(54) APPARATUS AND METHOD OF OPERATION FOR REFORMER AND FUEL CELL SYSTEM

(71) Applicant: DELPHI TECHNOLOGIES, INC., (US)

(72) Inventor: BERNARD A. FISCHER, HONEOYE FALLS, NY (US)

(73) Assignee: DELPHI TECHNOLOGIES, INC., TROY, MI (US)

(21) Appl. No.: 13/688,964

(22) Filed: Nov. 29, 2012

(51) Int. Cl. H01M 8/0612; H01M 8/04089; H01M 8/2425; H01M 8/04007

(52) U.S. Cl. CPC H01M 8/0618; H01M 8/04074; H01M 8/04089; H01M 8/2425

(57) ABSTRACT

Combined reformer and fuel cell systems, and their methods of operation, are described in which air is introduced to the system to produce additional water by reacting with hydrogen produced from the reformer during the reformer's startup partial oxidation mode of operation.

### RELATIONSHIP TO GOVERNMENT CONTRACTS

This invention was made with Government support under DE-FC26-02NT41246 awarded by DOE. The Government has certain rights in this invention.

### BACKGROUND OF THE INVENTION

This invention relates to fuel cell systems that include a catalytic reformer to produce reformate as a source of fuel for fuel cell(s) in the system.

Catalytic reformers are often used in fuel cell systems to provide fuel for the fuel cells. Catalytic reformers are often paired with solid oxide fuel cells (SOFC's) because SOFC's can use each of the hydrogen and carbon monoxide reformate components produced by the catalytic reformer as fuel. An SOFC comprises a cathode layer, an electrolyte layer formed of a solid oxide bonded to the cathode layer, and an anode layer bonded to the electrolyte layer on a side opposite from the cathode layer. In use of the cell, air is passed over the surface of the cathode layer, and oxygen from the air migrates through the electrolyte layer and reacts in the anode with hydrogen being passed over the anode surface, forming water and thereby creating an electrical potential between the anode and the cathode of about 1 volt. Typically, each individual fuel cell is arranged as a stage in a stack of fuel cells connected in series to produce a target operating voltage.

Partial-oxidizing (POX) reformers typically are operated exothermically by using intake air to partially oxidize hydrocarbon fuel as may be represented by the following equation for a hydrocarbon and air:

C₇H₁₂+3.5(O₂+3.76N₂)→6H₂+7CO+13.16N₂+heat (Eq. 1).

POX reformers typically are operated slightly fuel-lean of stoichiometric to prevent coking of the anodes from decomposition of non-reformed hydrocarbon within the fuel cell stack. Thus some full combustion of hydrocarbon and reformate occurs within the reformer in addition to, and in competition with, the electrochemical combustion of the fuel cell process. Such full combustion is wasteful of fuel and creates additional heat which must be removed from the reformate and/or stack, typically by passing a superabundance of cooling air through the cathode side of the stack

It is known to produce a reformate containing hydrogen and carbon monoxide by endothermic steam reforming (SR) of hydrocarbon in the presence of water in the so-called “water gas” process, which may be represented by the following equation:

C₇H₁₂+7H₂O+heat.→13H₂+7CO (Eq. 2)

Many known fuel cell systems use water in the reforming process, either recovered from the fuel cell exhaust or supplied to the system. In the case of recovered water, a large heat exchanger is required to condense the water, adding mass, cost, and parasitic losses to the system. In the case of supplied water, the water must be filtered and deionized, resulting in added cost, complexity, and maintenance requirements. In addition, for vehicular applications, the water must be stored, transported with the reformer, and periodically replenished.

It is also known to produce a reformate containing hydrogen and carbon monoxide by endothermic reforming of hydrocarbon in the presence of carbon dioxide in the so-called “dry reforming” process, which may be represented by the following equation:

C₇H₁₂+7CO₂+heat→6H₂+14CO (Eq. 3).

U.S. Pat. No. 7,326,482 discloses a highly efficient fuel cell system comprising a reformer and an SOFC stack where a portion of the spent fuel stream (i.e., tail gas) from the fuel cell stack, which contains H₂O and CO₂, is introduced to the inlet of the reformer. The patent discloses that at steady state operation, H₂O and CO₂ in the tail gas provide the oxygen necessary for catalytic reformation of hydrocarbons according to equations (2) and (3) above. A portion of the tail gas is also introduced to a combustor along with exhaust air from the fuel cell stack and combusted to provide heat to the catalytic reformer with combustion exhaust discharged to the atmosphere. The patent further discloses that the added water to the reformer increases protection against anode coking in the fuel cell. However, at startup there is insufficient water and carbon dioxide in the tail gas to provide enough oxygen to reform the fuel, so the patent teaches that air must be provided to the reformer at startup. The patent does not disclose a way of obtaining water's anti-coking benefits during the start-up phase when the tail gas does not contain high amounts of water.

### SUMMARY OF THE INVENTION

A method of operating a fuel cell system is provided for a fuel system that comprises a catalytic reformer having an inlet and an outlet, and a fuel cell assembly that comprises a plurality of fuel cells having cathodes and anodes, an air passage in contact with the fuel cell cathodes and having an air inlet and exhaust outlet, and a reformate passage in contact with the fuel cell anodes and having a reformate inlet and a tail gas outlet. The method comprises:
(a) introducing fuel and air to the catalytic reformer inlet;
(b) operating the catalytic reformer to produce a reformate stream comprising hydrogen and carbon monoxide from the reformer outlet, the operation of the catalytic reformer performed under partial oxidation conditions during a start-up mode and under endothermic conditions during a steady state mode;
(c) introducing reformate from the reformate stream to the fuel cell assembly reformate inlet, and introducing air to the fuel cell assembly air inlet to produce electricity, an air exhaust stream from the fuel cell assembly air exhaust outlet, and a tail gas stream from the fuel cell assembly tail gas outlet;
(d) introducing the tail gas stream to the reformer inlet;
(e) during the start-up mode: introducing oxygen to the reformate stream downstream of the reformer outlet and upstream of the fuel cell assembly reformate inlet, or introducing oxygen to the tail gas stream downstream of the fuel cell assembly tail gas outlet and upstream of the reformer inlet, or introducing oxygen to the reformate stream downstream of the reformer outlet and upstream of the fuel cell assembly reformate inlet and introducing oxygen to the tail gas stream downstream of the fuel cell assembly tail gas outlet and upstream of the reformer inlet; and
(f) reacting the oxygen introduced in (e) with hydrogen and carbon monoxide in the reformate stream, the tail gas stream, or both the reformate and tail gas streams to produce water in the reformate stream, the tail gas stream, or both the reformate and tail gas streams.

Also provided is a fuel cell system comprising:
(a) a catalytic reformer having an inlet and an outlet;
(b) a fuel cell assembly that comprises a plurality of fuel cells having cathodes and anodes, an air passage in contact with the fuel cell cathodes and having an air inlet and exhaust outlet, and a reformate passage in contact with the fuel cell anodes and having a reformate inlet and a tail gas outlet, the reformate inlet being in fluid communication with the reformer outlet; and
(c) a combustor having a tail gas inlet in fluid communication with the fuel cell assembly tail gas outlet, an air inlet, and an outlet in fluid communication with the reformer inlet.

Also provided is a fuel cell system comprising:
(a) a catalytic reformer having an inlet and an outlet;
(b) a fuel cell assembly that comprises a plurality of fuel cells having cathodes and anodes, an air passage in contact with the fuel cell cathodes and having an air inlet and exhaust outlet, and a reformate passage in contact with the fuel cell anodes and having a reformate inlet and a tail gas outlet, the reformate inlet being in fluid communication with the reformer outlet; and
(c) an air inlet in the reformate stream between the reformer outlet and the fuel cell assembly reformate inlet.

In some embodiments, heat generated by the reaction of oxygen with hydrogen and carbon monoxide from the reformate stream and/or tail gas stream is removed. In some embodiments, sufficient heat is removed to maintain the reformate stream temperature at or below 900° C., more specifically less than 850° C., and even more specifically less than 750° C. Heat can be removed actively with heat exchangers or passively by heat flow to the surrounding thermal mass in the system.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic drawing of a fuel cell system in which fuel cell tail gas is combusted with air and fed to a catalytic reformer;

FIG. 2 is a schematic drawing of a fuel cell system in which air is added to a reformate stream; and

FIG. 3 is a schematic drawing of a fuel cell system in which fuel cell tail gas is combusted with air and fed to a catalytic reformer and in which air is added to a reformate stream

### DETAILED DESCRIPTION

Referring now to the Figures, the invention will be described with reference to specific embodiments, without limiting same. The figures are not intended to represent comprehensive diagrams of all components, but only those components necessary for illustrating the concepts and principles described herein. Missing components, including but not limited to pumps, sensors, control valves, etc., will be readily inferred by those of ordinary skill in the art. Where practical, reference numbers for like components are commonly used among multiple figures.

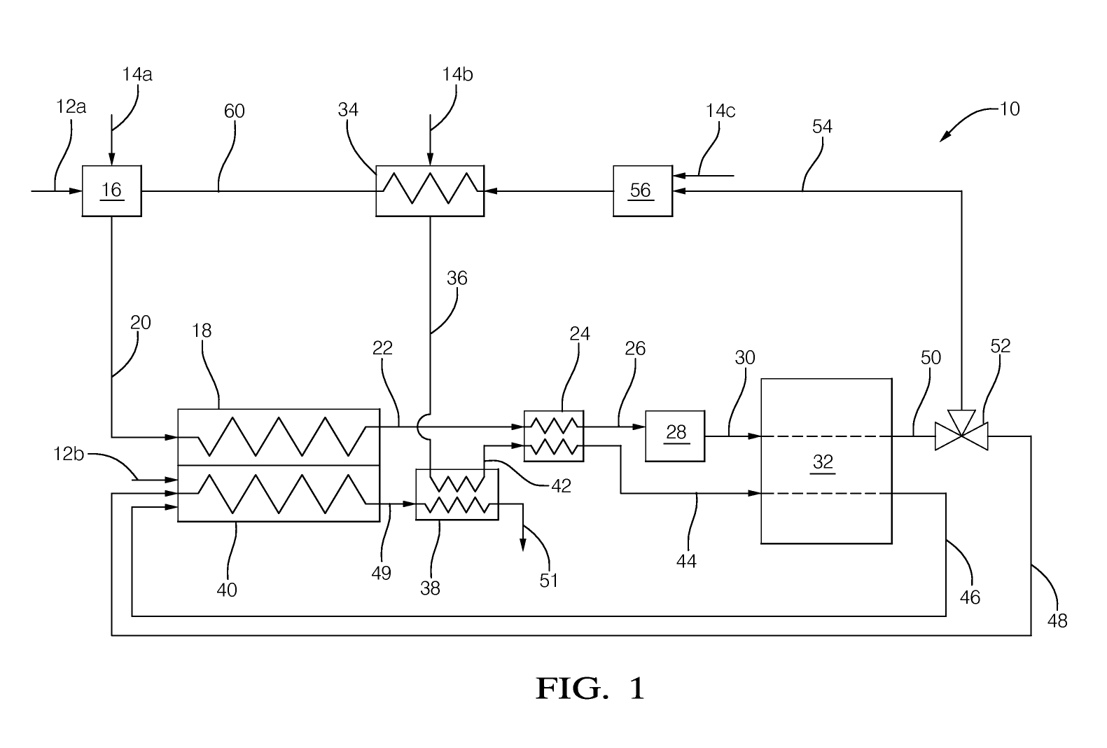

Referring to FIG. 1, fuel cell system 10 is shown with fuel feed 12a and air feed 14a introduced to a fuel delivery unit 16, which in turn delivers a fuel air mixture to catalytic reformer 18 through conduit 20. The catalytic reformer 18 produces reformate that contains hydrogen and carbon monoxide, and delivers the reformate through conduit 22 to equalizer heat exchanger 24 where the temperatures of the reformate and cathode air feed for the fuel cell are equalized. Reformate exiting from the heat exchanger 24 is delivered through conduit 26 to fuel desulfurizer 28, from where it is delivered through conduit 30 to the anode inlet of fuel cell stack 32. The air feed 14b for the cathode side of the fuel cell stack 32 is introduced to recycle cooler heat exchanger 34 where it is heated by hot tail gas discharged from the fuel cell stack 32. Air is delivered from the recycle cooler heat exchanger 34 through conduit 36 to cathode air pre-heat heat exchanger 38 where the air is further heated by exhaust from combustor/heat exchanger 40, from where it is delivered through conduit 42 to equalizer heat exchanger 24 and then through conduit 44 to the cathode inlet of fuel cell stack 32. Exhaust air from the fuel cell stack 32 is delivered through conduit 46 to combustor/heat exchanger 40, where it is combusted with fuel feed 12b and/or tail gas delivered through conduit 48. The combustion exhaust from combustor/heat exchanger 40 is delivered through conduit 49 to cathode air preheat heat exchanger 38 where it pre-heats cathode air feed for the fuel cell and then is discharged through exhaust 51. Fuel cell tail gas containing CO₂ and water along with unspent fuel exits the fuel cell stack 32 through conduit 50, and is distributed through control valve 52 through conduit 48 as fuel for combustor/heat exchanger 40 and/or through conduit 54 to be recycled back to the catalytic reformer 18. The tail gas recycle stream in conduit 54 is introduced to combustor 56 where it can be combusted during operation of the catalytic reformer 18 in exothermic partial oxidation mode during startup of the system. The outlet of combustor 56 delivers the recycle stream through conduit 58 to the recycle cooler heat exchanger 34, from where it flows through conduit 60 (optionally with the aid of a pump (not shown)) to fuel delivery unit 16.

During operation of the FIG. 1 system at startup, heat is initially supplied to the catalytic reformer 18 to bring the catalyst up to operating temperatures (e.g., 350° C. to 600° C.). This heat can be supplied by combusting fuel 12b in heat exchanger combustor 40 to provide heat to the catalytic reformer, and/or fuel delivery unit 16 can include a heating functionality to pre-heat the air/fuel mixture, and/or the catalyst can be heated by electrical resistance heating. After the catalyst reaches operating temperature, the reformer will be operating in exothermic partial oxidation mode with oxygen for the reforming reaction coming primarily from atmospheric oxygen. During this stage of operation, water can be introduced to the system shown in FIG. 1 by combusting tail gas in the combustor 56 to produce water, and recycling the combustion reaction products into catalytic reformer 18. In some embodiments, all of the tail gas stream is combusted in the combustor 56. Any excess heat from the combustion not utilized to pre-heat the cathode air in the cathode air pre-heat heat exchanger 34 can be discharged outside of the system, pumped elsewhere in the system to enhance overall thermal efficiency, or stored for later use in the system (e.g., to provide heat for the endothermic reforming stage that will follow the startup exothermic reforming stage).

During operation of the FIG. 1 system at steady state, the catalytic reformer 18 operates endothermically, utilizing oxygen supplied by water and CO₂ in the tail gas recycle for reforming according to equations (2) and/or (3) above, with little or no added air. Heat is supplied for the endothermic reaction by the combustion of a portion of the tail gas in combustor/heat exchanger 40. During this steady state endothermic stage of operation, combustor 56 is inactive, with the tail gas recycle either flowing through the combustor with no air feed 14c added and no combustion, or the tail gas recycle can be routed around the combustor 56 to cathode air pre-heat heat exchanger 34.

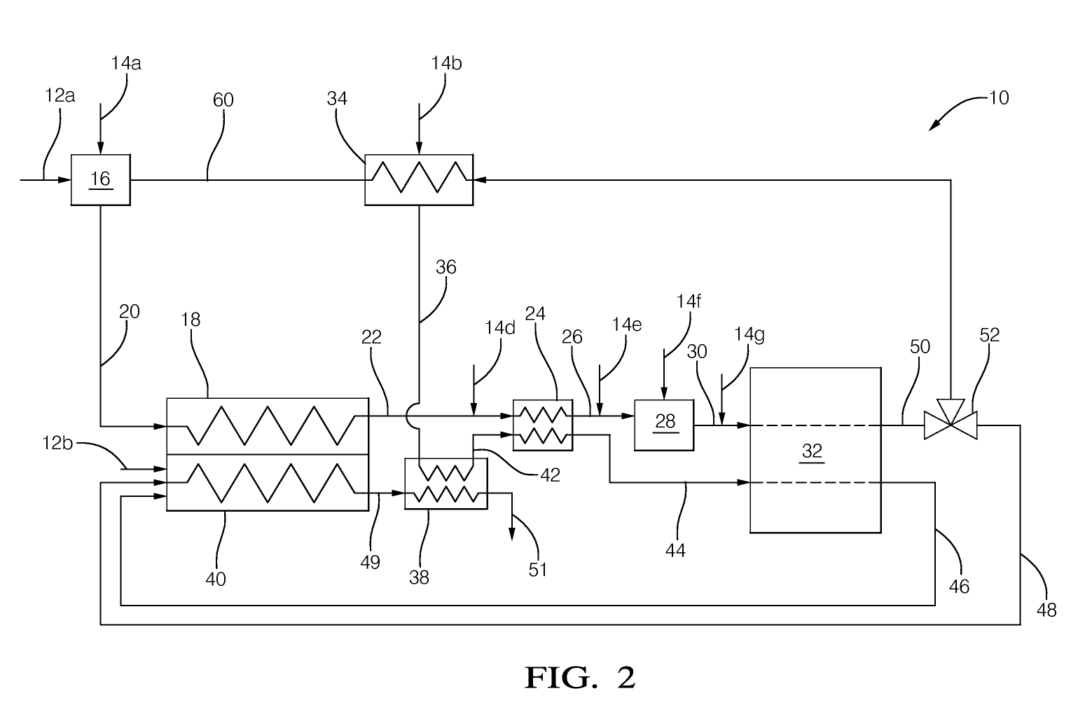

Turning now to FIG. 2, fuel feed 12a and air feed 14a are introduced to a fuel delivery unit 16, which in turn delivers a fuel air mixture to catalytic reformer 18 through conduit 20. The catalytic reformer 18 produces reformate that contains hydrogen and carbon monoxide, and delivers the reformate through conduit 22 to equalizer heat exchanger 24 where the temperatures of the reformate and cathode air feed for the fuel cell are equalized. Conduit 22 also includes air inlet 14d. Reformate exiting from the heat exchanger 24 is delivered through conduit 26 to fuel desulfurizer 28, from where it is delivered through conduit 30 to the anode inlet of fuel cell stack 32. Conduit 26 also includes air inlet 14e, fuel desulfurizer 28 includes an air inlet 14f, and conduit 30 includes air inlet 14g. The air feed 14b for the cathode side of the fuel cell stack 32 is introduced to recycle cooler heat exchanger 34 where it is heated by hot tail gas discharged from the fuel cell stack 32. Air is delivered from the recycle cooler heat exchanger 34 through conduit 36 to cathode air pre-heat heat exchanger 38 where the air is further heated by exhaust from combustor/heat exchanger 40, from where it is delivered through conduit 42 to equalizer heat exchanger 24 and then through conduit 44 to the cathode inlet of fuel cell stack 32. Exhaust air from the fuel cell stack 32 is delivered through conduit 46 to combustor/heat exchanger 40, where it is combusted with fuel feed 12b and/or tail gas delivered through conduit 48. The combustion exhaust from combustor/heat exchanger 40 is delivered through conduit 49 to cathode air preheat heat exchanger 38 where it pre-heats cathode air feed for the fuel cell and then is discharged through exhaust 51. Fuel cell tail gas containing CO₂ and water along with unspent fuel exits the fuel cell stack 32 through conduit 50, and is distributed through control valve 52 through conduit 48 as fuel for combustor/heat exchanger 40 and/or through conduit 54 to be recycled back to the catalytic reformer 18. The tail gas recycle stream in conduit 54 is introduced to the recycle cooler heat exchanger 34, from where it flows through conduit 60 (optionally with the aid of a pump (not shown)) to fuel delivery unit 16.

During operation of the FIG. 2 system at startup, heat is initially supplied to the catalytic reformer 18 to bring the catalyst up to operating temperatures (e.g., 700° C. to 1000° C.). This heat can be supplied by combusting fuel 12b in heat exchanger combustor 40 to provide heat to the catalytic reformer, and/or fuel delivery unit 16 can include a heating functionality to pre-heat the air/fuel mixture, and/or the catalyst can be heated by electrical resistance heating. After the catalyst reaches operating temperature, the reformer will be operating in exothermic partial oxidation mode with oxygen for the reforming reaction coming primarily from atmospheric oxygen. During this stage of operation, water can be introduced to the system shown in FIG. 2 by adding oxygen to the reformate stream downstream of the catalytic reformer 18 and upstream of the fuel cell stack 32. The oxygen will react with hydrogen in the reformate stream to produce water. As this reaction is highly exothermic, care must be taken to control the rate at which air is added to the reformate stream. Adding air at too high a rate can produce heat sufficient to drive temperatures in the reformate stream, and adding all of the air required to produce the desired amount of water in the reformate stream at a single location can produce detrimental temperature levels. However, during the startup mode, the temperature of surrounding materials and components of the system is typically lower than it is at steady state, thereby creating a higher temperature gradient so that sufficient heat can be transferred to the surrounding thermal mass of the system materials and components if the air is added to the reformate stream at a plurality of locations. These locations should be sufficiently spaced apart so that sufficient heat can be transferred away from the reformate stream before additional air is added. In some embodiments, the locations are sufficiently spaced apart to maintain any surrounding steel (including stainless, austenitic 300 series, and ferritic 400 series steels) at or below 800° C. (more specifically at or below 750° C.), and/or any surrounding nickel-based components (including Inconel and similar alloys) at or below 950° C. (more specifically below 850° C.)

In some exemplary embodiments, air is added at two or more locations of the reformate stream. In some exemplary embodiments, air is added at three or more locations of the reformate stream. In a more specific exemplary embodiment, the system includes a heat exchanger having one side disposed in the reformate stream between the reformate outlet and the fuel cell assembly reformate inlet and one side disposed in an air flow feed stream connected to the fuel cell assembly air inlet, a desulfurizer disposed in the reformate stream between the heat exchanger and the fuel cell assembly reformate inlet, a first air inlet in the reformate stream at three locations selected from the group consisting of: a first location between the reformer outlet and the heat exchanger, a second air inlet at a second location between the heat exchanger and the desulfurizer, a third air inlet at a third location inside the desulfurizer, and a fourth air inlet at a fourth location between the desulfurizer and the fuel cell assembly reformate inlet.

During operation of the FIG. 2 system at steady state, the catalytic reformer 18 operates endothermically, utilizing oxygen supplied by water and CO₂ in the tail gas recycle for reforming according to equations (2) and/or (3) above, with little or no added air. Heat is supplied for the endothermic reaction by the combustion of a portion of the tail gas in combustor/heat exchanger 40. During this steady state endothermic stage of operation, the air feeds 14d, 14e, and 14f are inactive.

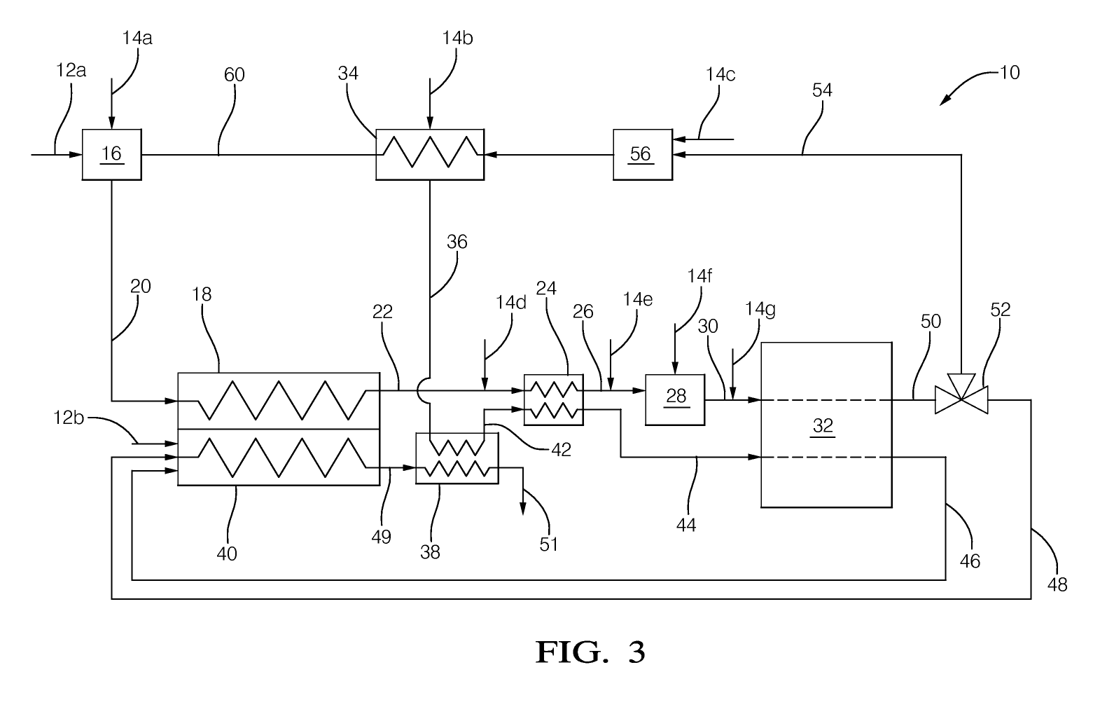

Turning now to FIG. 3, fuel feed 12a and air feed 14a are introduced to a fuel delivery unit 16, which in turn delivers a fuel air mixture to catalytic reformer 18 through conduit 20. The catalytic reformer 18 produces reformate that contains hydrogen and carbon monoxide, and delivers the reformate through conduit 22 to equalizer heat exchanger 24 where the temperatures of the reformate and cathode air feed for the fuel cell are equalized. Conduit 22 also includes air inlet 14d. Reformate exiting from the heat exchanger 24 is delivered through conduit 26 to fuel desulfurizer 28, from where it is delivered through conduit 30 to the anode inlet of fuel cell stack 32. Conduit 26 also includes air inlet 14e, fuel desulfurizer 28 includes an air inlet 14f, and conduit 30 includes air inlet 14g. The air feed 14b for the cathode side of the fuel cell stack 32 is introduced to recycle cooler heat exchanger 34 where it is heated by hot tail gas discharged from the fuel cell stack 32. Air is delivered from the recycle cooler heat exchanger 34 through conduit 36 to cathode air pre-heat heat exchanger 38 where the air is further heated by exhaust from combustor/heat exchanger 40, from where it is delivered through conduit 42 to equalizer heat exchanger 24 and then through conduit 44 to the cathode inlet of fuel cell stack 32. Exhaust air from the fuel cell stack 32 is delivered through conduit 46 to combustor/heat exchanger 40, where it is combusted with fuel feed 12b and/or tail gas delivered through conduit 48. The combustion exhaust from combustor/heat exchanger 40 is delivered through conduit 49 to cathode air preheat heat exchanger 38 where it pre-heats cathode air feed for the fuel cell and then is discharged through exhaust 51. Fuel cell tail gas containing CO₂ and water along with unspent fuel exits the fuel cell stack 32 through conduit 50, and is distributed through control valve 52 through conduit 48 as fuel for combustor/heat exchanger 40 and/or through conduit 54 to be recycled back to the catalytic reformer 18. The tail gas recycle stream in conduit 54 is introduced to combustor 56 where it can be combusted during operation of the catalytic reformer 18 in exothermic partial oxidation mode during startup of the system. The outlet of combustor 56 delivers the recycle stream through conduit 58 to the recycle cooler heat exchanger 34, from where it flows through conduit 60 (optionally with the aid of a pump (not shown)) to fuel delivery unit 16.

During operation of the FIG. 3 system at startup, heat is initially supplied to the catalytic reformer 18 to bring the catalyst up to operating temperatures (e.g., 300° C. to 600° C.). This heat can be supplied by combusting fuel 12b in heat exchanger combustor 40 to provide heat to the catalytic reformer, and/or fuel delivery unit 16 can include a heating functionality to pre-heat the air/fuel mixture, and/or the catalyst can be heated by electrical resistance heating. After the catalyst reaches operating temperature, the reformer will be operating in exothermic partial oxidation mode with oxygen for the reforming reaction coming primarily from atmospheric oxygen. During this stage of the reaction, water can be introduced to the system shown in FIG. 3 by adding oxygen to the reformate stream downstream of the catalytic reformer 18 and upstream of the fuel cell stack 32. The oxygen will react with hydrogen in the reformate stream to produce. As this reaction is highly exothermic, care must be taken to control the rate at which air is added to the reformate stream. Adding air at too high a rate can produce heat sufficient to drive temperatures in the reformate stream, and adding all of the air required to produce the desired amount of water in the reformate stream at a single location can produce detrimental temperature levels. However, water can also be introduced to the system shown in FIG. 1 by combusting tail gas in the combustor 56 to produce water, and recycling the combustion reaction products into catalytic reformer 18, so adding some oxygen to a single location in the reformate stream can be combined with adding oxygen to the combustor 56. In some exemplary embodiments, all of the tail gas is combusted in combustor 56. In some exemplary embodiments, air is added at two or more locations of the reformate stream. In some exemplary embodiments, air is added at three or more locations of the reformate stream. In a more specific exemplary embodiment, the system includes a heat exchanger having one side disposed in the reformate stream between the reformate outlet and the fuel cell assembly reformate inlet and one side disposed in an air flow feed stream connected to the fuel cell assembly air inlet, a desulfurizer disposed in the reformate stream between the heat exchanger and the fuel cell assembly reformate inlet, a first air inlet in the reformate stream at three locations selected from the group consisting of: a first location between the reformer outlet and the heat exchanger, a second air inlet at a second location between the heat exchanger and the desulfurizer, a third air inlet at a third location inside the desulfurizer, and a fourth air inlet at a fourth location between the desulfurizer and the fuel cell assembly reformate inlet.

During operation of the FIG. 3 system at steady state, the catalytic reformer 18 operates endothermically, utilizing oxygen supplied by water and CO₂ in the tail gas recycle for reforming according to equations (2) and/or (3) above, with little or no added air. Heat is supplied for the endothermic reaction by the combustion of a portion of the tail gas in combustor/heat exchanger 40. During this steady state endothermic stage of operation, the air feeds 14d, 14e, 14f, and 14g are inactive, and combustor 56 is inactive, with the tail gas recycle either flowing through the combustor with no air feed 14c added and no combustion. Alternatively, the tail gas recycle can be routed around the combustor 56 to cathode air pre-heat heat exchanger 34.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

1. A method of operating a fuel cell system comprising a catalytic reformer having an inlet and an outlet, and a fuel cell assembly that comprises a plurality of fuel cells having cathodes and anodes, an air passage in contact with the fuel cell cathodes and having an air inlet and exhaust outlet, and a reformate passage in contact with the fuel cell anodes and having a reformate inlet and a tail gas outlet, the method comprising:
(a) introducing fuel and air to the catalytic reformer inlet;
(b) operating the catalytic reformer to produce a reformate stream comprising hydrogen and carbon monoxide from the reformer outlet, the operation of the catalytic reformer performed under partial oxidation conditions during a start-up mode and under endothermic conditions during a steady state mode;
(c) introducing reformate from the reformate stream to the fuel cell assembly reformate inlet, and introducing air to the fuel cell assembly air inlet to produce electricity, an air exhaust stream from the fuel cell assembly air exhaust outlet, and a tail gas stream from the fuel cell assembly tail gas outlet;
(d) introducing the tail gas stream to the reformer inlet;
(e) during the start-up mode: introducing oxygen to the tail gas stream downstream of the fuel cell assembly tail gas outlet and upstream of the reformer inlet; and
(f) reacting the oxygen introduced in (e) with hydrogen and carbon monoxide in the tail gas stream to produce water in the tail gas stream.

2. The method of claim 1, further comprising removing heat generated by the reaction of oxygen with hydrogen and carbon monoxide from the reformate stream or the tail gas stream.

3. The method of claim 2, wherein sufficient heat is removed to maintain the reformate stream temperature at or below 900° C.

4. The method of claim 2, wherein sufficient heat is removed to maintain the temperature of metal components in contact with the reformate stream at a temperature at or below 800° C.

5. The method of claim 2, wherein sufficient heat is removed to maintain the temperature of metal components in contact with the reformate stream at a temperature at or below 950° C.

6. (canceled)

7. The method of claim 1, wherein oxygen is introduced to the tail gas stream at a rate sufficient to react with all of the hydrogen and carbon monoxide therein.

8. The method of claim 1, wherein oxygen is introduced to the tail gas stream and reacted in a combustor.

9. The method of claim 7, wherein oxygen is introduced to the tail gas stream and reacted in a combustor.

10. The method of claim 2, wherein heat from the reaction of oxygen with hydrogen and carbon monoxide in the tail gas stream is transferred to the air that is introduced to the fuel cell assembly.

11-16. (canceled)

17. The method of claim 1, wherein oxygen is introduced to the reformate stream downstream of the reformer outlet and upstream of the fuel cell assembly reformate inlet.

18. The method of claim 17, wherein oxygen is introduced to the tail gas stream in an amount sufficient to react with all of the hydrogen and carbon monoxide in the tail gas stream, and oxygen is introduced to the reformate stream at a single location downstream of the reformer outlet and upstream of the fuel cell assembly reformate inlet at a rate sufficiently low to maintain reformate stream at a temperature at or below 900° C.

19. A fuel cell system comprising:
(a) a catalytic reformer having an inlet and an outlet;
(b) a fuel cell assembly that comprises a plurality of fuel cells having cathodes and anodes, an air passage in contact with the fuel cell cathodes and having an air inlet and exhaust outlet, and a reformate passage in contact with the fuel cell anodes and having a reformate inlet and a tail gas outlet, the reformate inlet being in fluid communication with the reformer outlet; and
(c) a combustor having a tail gas inlet in fluid communication with the fuel cell assembly tail gas outlet, an air inlet, and an outlet in fluid communication with the reformer inlet.

20. The fuel cell system of claim 19, further comprising an air inlet in the reformate stream between the reformer outlet and the fuel cell assembly reformate inlet.

21-24. (canceled)
